(19) United States
(12) Patent Application Publication
(10) Pub. No.: US 2008/0155392 A1
(43) Pub. Date: Jun. 26, 2008

(54) Integrity Checker for Web Browser Document

(75) Inventor: Daryl David Coutts, Edmonton (CA)

Correspondence Address: Daryl D. Coutts, Suite 207, 11103 84 Ave, Edmonton, AB, T6G 2X4, omitted

(73) Assignee: MARENGO INTELLECTUAL PROPERTY LTD., Edmonton (CA)

(21) Appl. No.: 12/040,869

(22) Filed: Mar. 1, 2008

Related U.S. Application Data
(60) Provisional application No. 60/904,358, filed on Mar. 2, 2007.

(51) Int. Cl. G06F 17/00

(52) U.S. Cl. 715/229; 715/234

(57) ABSTRACT

An apparatus and method for integrity checking of a document associated with a web browser is described.

### CROSS REFERENCE TO RELATED APPLICATIONS

This application claims the benefit of priority under 35 USC 119(e) to U.S. Provisional Application No. 60/904,358, filed Mar. 2, 2007, entitled “Integrity Checker for Web Browser Document”, all of which is incorporated herein by reference in its entirety.

### TECHNICAL FIELD

The invention relates to an apparatus and method that determines if a document associated with a web browser has changed.

### BACKGROUND OF THE INVENTION

Individuals and corporations expend significant resources to produce content for web pages. These producers of content want to ensure that their content is presented in a way that they envisaged. However, in today's online world it is now possible for content modifiers to sample web page content, reformat it and then re-present the content—often in ways that are disagreeable to the original content producer.

What is needed is a way for content producers to deploy web pages and ensure that their deployed web pages are not modified in an unauthorized manner at a client computing device.

### BRIEF SUMMARY OF THE INVENTION

A web browser is available on a computing device. A computer program product running on the computing device obtains first information associated with a document, the document associated with the web browser. In response to an event, the computer program product obtains second information associated with the document. The first information is compared with the second information and based on the comparison a second set of computer instructions is executed.

The event to which the computer program product responds can be any type of event such as the expiry of a timer or an event generated by the web browser. The execution of the second set of computer instructions may comprise issuing an instruction to the web browser, navigating the web browser, refreshing a page in the web browser, displaying a pop-up window or issuing an instruction to the Document Object Model associated with the document.

Other objects, features and advantages of the present invention will become apparent upon perusal of the following description in conjunction with the appended drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary block diagram of several software modules running on a computing device.

FIG. 2 illustrates an exemplary method that can be used to determine if a document has been modified.

### DESCRIPTION OF EMBODIMENTS

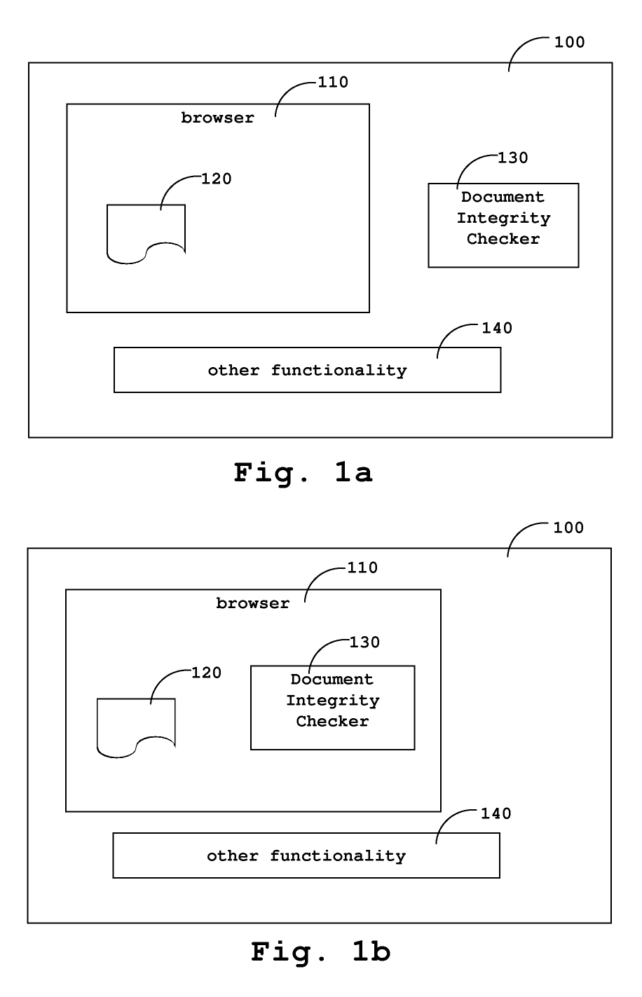

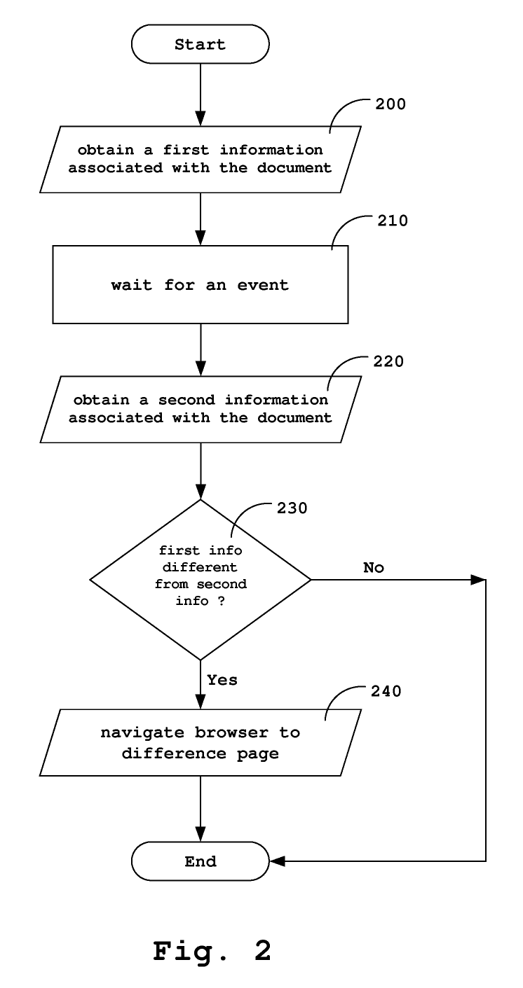

FIG. 1a is a block diagram of several software modules running on a computing device 100. The computing device 100 can be any computing device such as a desktop computer, notebook computer, cellphone, personal digital assistant, handheld computer or set top box. The computing device 100 has memory, not shown, that can be permanent or temporary or both permanent and temporary. The computing device 100 also has an associated display that is not shown in FIG. 1. Block 110 represents a web browser. Block 120 represents a document associated with the web browser 110. Block 130 is a document integrity checker that determines if the document 120 associated with the web browser 110 has been altered in an unauthorized manner. The functionality of the document integrity checker 130 is discussed later in the discussion of FIG. 2. FIG. 1a illustrates that the document integrity checker 130 functionality can be provided as a separate application from the web browser 110. FIG. 1b illustrates that the document integrity checker 130 functionality may be integrated into the web browser 110 as an add-on, toolbar or extension or as part of the web browser 110 application itself. Block 140 represents other software modules executing on the computing device 100 such as the operating system and communication system.

FIG. 2 illustrates a method that can be implemented to check the integrity of the document 120. In block 200, first information associated with the document 120 is obtained. An exemplary way to implement block 200 is with the Javascript statement

sTest=document.documentElement.innerHTML;
after this statement is executed, the variable stest will have first information associated with the document 120. Other ways of obtaining information associated with the document 120 are of course possible. The information obtained from the document 120 could be checksum information or watermark information or some other kind of encoded information.

In block 210, an event is detected. Any type of event may be detected in block 210, examples of such events include a timer expiry or an event associated with the web browser 110 such as a Document_Complete indication. In block 220, second information associated with the document 120 is obtained. Next, in block 230, the first information is compared with the second information. If the comparison in block 230 is favorable, no further action need be taken. If the comparison in block 230 is not favorable, then the method moves to block 240. In block 240, many types of actions can be taken such as navigating the web browser 110, refreshing a page in the web browser 110, displaying a pop-up window or issuing an instruction to the Document Object Model associated with the document 120.

The method illustrated in FIG. 2 can be implemented by the document integrity checker 130. Computer executable instructions for carrying out the method illustrated in FIG. 2 may be stored on any suitable media readable by a computer such as floppy disks, hard disks, CD-ROMS, DVDs, Flash ROMs, non-volatile ROM and RAM. The functionality described herein may be implemented in a web browser add-on, add-in, extension, plug-in, helper object or any other type of application function extender. The functionality described herein may be implemented in computer executable instructions associated with a web page.

While various embodiments have been described above, it should be understood that it has been presented by way of example only, and not limitation.

I claim:

1. A method of determining if a document associated with a web browser has been altered, the method comprising:
obtaining a first information associated with the document;
responding to an event by obtaining a second information associated with the document; and
comparing the first information with the second information and based on the comparison, executing a second set of computer instructions.

2. The method of claim 1 where responding to an event comprises responding to a timer expiry.

3. The method of claim 1 where responding to an event comprises responding to an event generated by the web browser.

4. The method of claim 1 where executing a second set of computer instructions comprises at least one selected from the list of issuing an instruction to the web browser, issuing an instruction to the Document Object Model associated with the document, navigating the web browser, refreshing a page in the web browser and displaying a pop-up window.

5. An add-on for a web browser, where the add-on performs a method of determining if a document associated with a web browser has been altered, the method comprising:
obtaining a first information associated with the document;
responding to an event by obtaining a second information associated with the document; and
comparing the first information with the second information and based on the comparison, executing a second set of computer instructions.

6. The add-on in claim 5 wherein the method it performs, responding to an event comprises responding to a timer expiry.

7. The add-on in claim 5 wherein the method it performs, responding to an event comprises responding to an event generated by the web browser.

8. The add-on in claim 5 wherein the method it performs, executing a second set of computer instructions comprises at least one selected from the list of issuing an instruction to the web browser, issuing an instruction to the Document Object Model associated with the document, navigating the web browser, refreshing a page in the web browser and displaying a pop-up window.

9. A computer-readable medium having computer-executable instructions for performing a method of determining if a document associated with a web browser has been altered, the method comprising:
obtaining a first information associated with the document;
responding to an event by obtaining a second information associated with the document; and comparing the first information with the second information and based on the comparison, executing a second set of computer instructions.

10. The computer-readable medium in claim 9 wherein the method performed by the computer-executable instructions, responding to an event comprises responding to a timer expiry.

11. The computer-readable medium in claim 9 wherein the method performed by the computer-executable instructions, responding to an event comprises responding to an event generated by the web browser.

12. The computer-readable medium in claim 9 wherein the method performed by the computer-executable instructions, executing a second set of computer instructions comprises at least one selected from the list of issuing an instruction to the web browser, issuing an instruction to the Document Object Model associated with the document, navigating the web browser, refreshing a page in the web browser and displaying a pop-up window.

13. The computer-readable medium in claim 9 where the computer-executable instructions are written in Javascript.
